(19) United States
(12) Patent Application Publication
(10) Pub. No.: US 2024/0404491 A1
(43) Pub. Date: Dec. 5, 2024

(54) DRUM PATCH AND HITTING SURFACE PROTECTION METHOD

(71) Applicant: Roland Corporation, Shizuoka (JP)

(72) Inventor: Ryo Kuroki, Shizuoka (JP)

(73) Assignee: Roland Corporation, Shizuoka (JP)

(21) Appl. No.: 18/674,897

(22) Filed: May 26, 2024

(30) Foreign Application Priority Data
May 31, 2023 (JP) 2023-090107

(51) Int. Cl. G10D 13/10; G10D 13/20

(52) U.S. Cl. CPC G10D 13/25; G10D 13/20

(57) ABSTRACT

A drum patch formed into a sheet shape is adhered to a hitting surface of a drum. Since a first slit and a second slit extending toward a hit region are formed at the outer edge of the drum patch, relatively flexible deformation is possible at the outer edge portion. Accordingly, the slits can absorb deformation in which the outer edge portion of the drum patch rises from the hitting surface when hitting the hit region. Thus, peeling of the drum patch from the hitting surface can be suppressed.

### CROSS-REFERENCE TO RELATED APPLICATION

This application claims the priority benefit of Japan application serial no. 2023-090107, filed on May 31, 2023. The entirety of the above-mentioned patent application is hereby incorporated by reference herein and made a part of this specification.

### BACKGROUND

### Technical Field

The disclosure relates to a drum patch and a hitting surface protection method and more particularly to a drum patch that can be suppressed from peeling off from a hitting surface and a hitting surface protection method using the drum patch.

### Related Art

There is known a technology of adjusting the sound produced during hitting and protecting a hitting surface of a drum from the impact of hitting by adhering a sheet-like drum patch to the hitting surface (for example, see U.S. Pat. No. 5,986,196 (FIG. 1 of U.S. Pat. No. 5,986,196)). This type of drum patch is generally adhered to the hitting surface with an adhesive or the like.

However, in the above-described conventional technology, the drum patch tends to peel off from the hitting surface due to the impact at the time of hitting.

### SUMMARY

A drum patch according to an embodiment of the disclosure is a drum patch that is formed into a sheet shape and is able to be adhered to a hitting surface of a drum, wherein a slit extending toward a hit region receiving hitting is formed at an outer edge.

A hitting surface protection method according to an embodiment of the disclosure is a hitting surface protection method for protecting a hitting surface of a drum using a drum patch formed in a sheet shape, wherein the drum patch in which a slit extending toward a hit region receiving hitting is formed at an outer edge is adhered to the hitting surface.

### BRIEF DESCRIPTION OF THE DRAWINGS

FIG. 1 is a perspective view of a drum to which a drum patch of a first embodiment is attached.

FIG. 2 is a front view of the drum patch of the first embodiment.

FIG. 3 is a front view of a drum patch of a second embodiment.

FIG. 4A is a front view of a drum patch of a third embodiment and FIG. 4B is a front view of a drum patch of a fourth embodiment.

FIG. 5A is a front view of a drum patch of a fifth embodiment and FIG. 5B is a front view of a drum patch of a sixth embodiment.

FIG. 6 is a front view of a drum patch of a seventh embodiment.

FIG. 7 is a front view of a drum patch of an eighth embodiment.

### DESCRIPTION OF THE EMBODIMENTS

Embodiments of the disclosure provide a drum patch that can be suppressed from peeling off from a hitting surface and a hitting surface protection method using the drum patch.

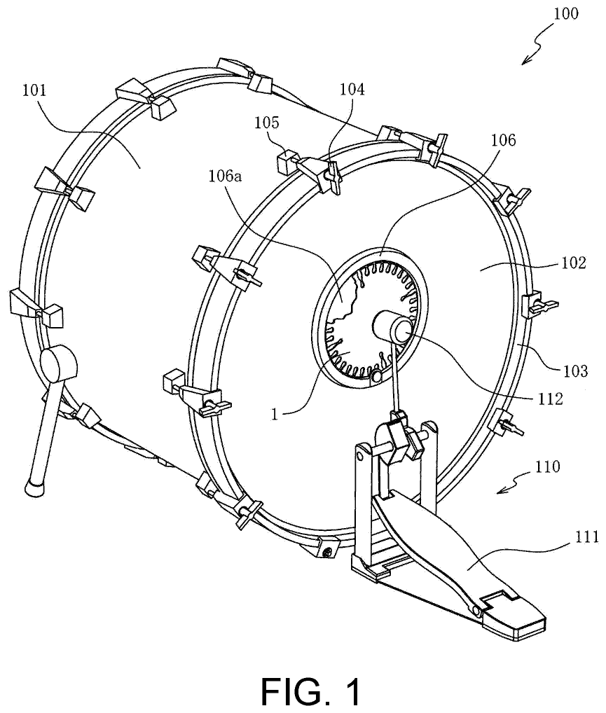

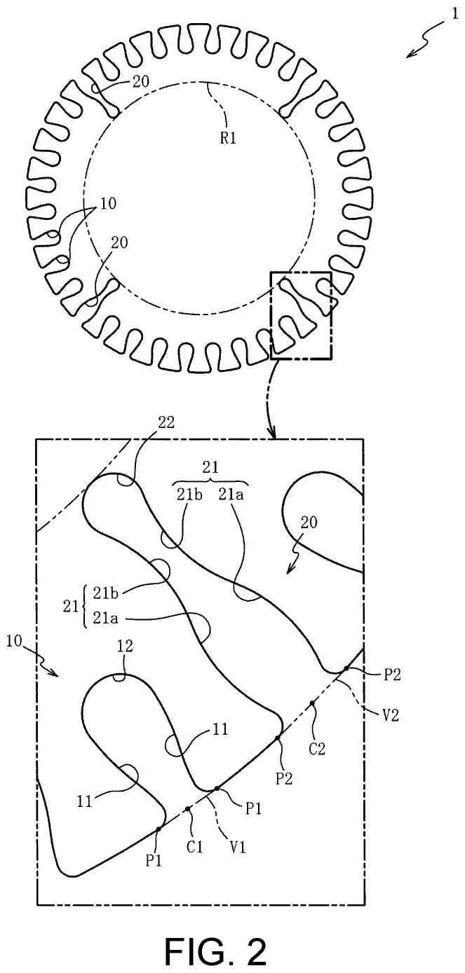

Hereinafter, exemplary embodiments will be described with reference to the accompanying drawings. First, a drum patch 1 of a first embodiment will be described with reference to FIG. 1. FIG. 1 is a perspective view of a drum 100 to which the drum patch 1 of the first embodiment is attached and FIG. 2 is a front view of the drum patch 1. Furthermore, in FIG. 1, the drum patch 1 is partially cut away.

As illustrated in FIG. 1, the drum 100 to which the drum patch 1 is attached is a percussion instrument (bass drum) having a cylindrical shell 101 whose opening at the axial end is closed with a head 102. The head 102 is formed into a disk shape using a synthetic resin film, and is attached to the shell 101 with an annular hoop 103.

Through holes (not illustrated) are formed in the hoop 103 at a plurality of positions in the circumferential direction, and tension bolts 104 are inserted into the through holes. A plurality of lugs 105 are provided on the outer circumferential surface of the shell 101, and tension is applied to the head 102 by screwing the tension bolt 104 into the lugs 105 while the outer edge of the head 102 is hooked on the hoop 103.

A through hole (not illustrated) is formed in the head 102, and a disk-shaped attachment 106 is attached to this through hole. The attachment 106 is a sound reduction tool for reducing the sound produced when hitting the head 102, and a mesh hitting surface 106a is formed on the surface of the attachment 106.

Although not illustrated in the drawings, the hitting surface 106a is stacked on a soft polyurethane pad (cushion), and the attachment 106 is equipped with a sensor (piezo element) that detects vibrations caused by hitting the hitting surface 106a. Furthermore, this attachment 106 can employ a known configuration, and as a known configuration, the hit portion 40 of International Publication No. 2017/038226 is exemplified.

The hitting surface 106a of the attachment 106 is hit by a foot pedal 110. The foot pedal 110 is of a single pedal type, and includes a pedal 111 that is depressed by the player, and a beater 112 that rotates when the pedal 111 is depressed.

When the hitting by the beater 112 is detected by the sensor of the attachment 106, a musical tone signal based on the detection result is generated by a sound source (not illustrated). The musical tone signal is output to an amplifier or a speaker (both not illustrated), so that an electronic musical tone is emitted from the speaker. That is, the drum 100 is configured as an electronic drum.

The drum patch 1 is adhered to the hitting surface 106a of the attachment 106 at a position receiving the hitting from the beater 112. The drum patch 1 is a film-like member for protecting the hitting surface 106a from impact caused by the beater 112, and covers substantially the entire hitting surface 106a.

As illustrated in FIG. 2, the drum patch 1 is formed into a circular shape when viewed from the front and a first slit 10 having a relatively shallow cutting depth and a second slit 20 having a deeper cutting depth than the first slit 10 are formed at the outer edge of the drum patch 1. Furthermore, a “slit” is a notch whose length in the longitudinal direction is greater (for example, 1.5 to 2 times or more) than its width, and the same applies to other embodiments described below.

A plurality of the first slits 10 are formed (at 32 positions in this embodiment) in a direction around the outer circumference of the drum patch 1 (hereinafter, referred to as the “circumferential direction”). The intervals between these first slits 10 in the circumferential direction are constant.

A plurality of the second slits 20 are formed (at 4 positions in this embodiment) in the circumferential direction of the drum patch 1, and the intervals between the plurality of second slits 20 in the circumferential direction are constant. That is, the second slits 20 are formed at positions that equally divide the plurality of first slits 10 (four equal parts).

In the following description, a description will be made on the assumption that a virtual circle contacting the edge of each second slit 20 when viewed from the front of the drum patch 1 is a hit region R1 and the side of the hit region R1 is the tip side of each of the slits 10 and 20. Furthermore, the hit region R1 is a region which is expected to be hit by the beater 112 (see FIG. 1), but the outside of the hit region R1 may be hit.

When the hitting by the beater 112 is applied to the hit region R1 of the drum patch 1, the hit region R1 of the drum patch 1 is deformed so as to be depressed. Therefore, for example, if the hit region R1 is hit when the slits 10 and 20 are not formed in the drum patch 1, the entire drum patch 1 is deformed in an undulating manner, and the outer edge of the drum patch 1 rises from the hitting surface 106a (see FIG. 1) and becomes easily peeled off.

In contrast, in this embodiment, since the first slit 10 and the second slit 20 extending toward the hit region R1 are formed at the outer edge portion of the drum patch 1, this outer edge portion can be relatively flexibly deformed. That is, the slits 10 and 20 can absorb deformation in which the outer edge portion of the drum patch 1 rises from the hitting surface 106a when hitting the hit region R1. Therefore, peeling of the drum patch 1 from the hitting surface 106a can be suppressed.

Further, since the entire hit region R1 is surrounded by the plurality of first slits 10 and second slits 20, deformation in which the outer edge of the drum patch 1 rises from the hitting surface 106a can be suppressed over the entire circumference of the drum patch 1 regardless of the hit position of the beater 112 in the hit region R1.

Further, since cach of the first slit 10 and the second slit 20 extends in the radial direction of the drum patch 1, the hit region R1 is radially surrounded by these slits 10 and 20. Accordingly, deformation in which the outer edge portion of the drum patch 1 rises from the hitting surface 106a can be effectively suppressed over the entire circumference of the drum patch 1.

Here, as illustrated in the enlarged part of FIG. 2, the line segment connecting the intersection points P1 (the points where the curvature of the outer edge of the drum patch 1 changes) between a pair of edges 11 extending in the longitudinal direction of the first slit 10 (the radial direction of the drum patch 1) and the outer edge of the drum patch 1 is assumed as a virtual line V1. Further, when the edge of the first slit 10 that connects the tips of the pair of edges 11 is a tip edge 12, the length of the line segment connecting the tip of the tip edge 12 (a part farthest from the midpoint C1 of the virtual line V1) and the midpoint C1 of the virtual line V1 is the length of the first slit 10.

Similarly, when the line segment connecting the intersection points P2 between the pair of edges 21 extending in the longitudinal direction of the second slit 20 and the outer edge of the drum patch 1 is assumed as a virtual line V2, the length of the line segment connecting a tip of a tip edge 22 of the second slit 20 that connects the pair of edges 21 to the midpoint C2 of the virtual line V2 is the length of the second slit 20.

Since the length of the second slit 20 is greater than the first slit 10, the second slit 20 can easily absorb the undulating deformation of the drum patch 1 when hitting the hit region R1. Therefore, peeling of the drum patch 1 from the hitting surface 106a can be suppressed.

Although it is preferable to form a large number of relatively long second slits 20 in order to suppress the undulating deformation of the drum patch 1, the region receiving the hitting from the beater 112 will be reduced when a large number of second slits 20 are formed. That is, although the region contacting the plurality of second slits 20 is described as the hit region R1, as described above, it is also assumed that the beater 112 hits the outside of the hit region R1. For this reason, if the number of second slits 20 is increased, the impact will be more likely to be applied to the hitting surface 106a when the outside of the hit region R1 is hit.

On the other hand, in this embodiment, since the number of second slits 20 (4) is smaller than the number of first slits 10 (20), it is possible to ensure a wide region outside the hit region R1 to receive the hitting from the beater 112 while suppressing the undulating deformation of the drum patch 1 by the second slit 20. Thus, the drum patch 1 can effectively protect the hitting surface 106a while suppressing the drum patch 1 from peeling off from the hitting surface 106a.

The distance between the pair of edges 11 of the first slit 10 gradually increases as it goes toward the tip edge 12, and these pair of edges 11 are connected by an arc (minor arc) tip edge 12. Further, the pair of edges 21 of the second slit 20 is similarly connected by the arc tip edge 22. By connecting the edges 11 and 21 of the slits 10 and 20 in an arc shape in this way, it is possible to suppress the generation of cracks from the tip edges 12 and 22 of the slits 10 and 20 due to the impact generated when hitting the hit region R1. Therefore, the durability of the drum patch 1 can be improved.

As described above, the length of the line segment connecting the tip of the tip edge 12 of the first slit 10 and the midpoint C1 of the virtual line V1 is the length of the first slit 10. That is, the direction along this line segment is the longitudinal direction of the first slit 10, and the direction perpendicular thereto is the width direction of the first slit 10. The same applies to the second slit 20.

In this case, each of the pair of edges 11 of the first slit 10 is curved toward the outside in the width direction of the first slit 10 (a curved portion is formed). Furthermore, curved portions 21a and 21b that curve outward and inward in the width direction of the second slit 20 are formed on the pair of edges 21 of the second slit 20. By curving the edges 11 and 21 of the slits 10 and 20 in this way, the edges 11 and 21 of the slits 10 and 20 are less likely to rise from the hitting surface 106a when hitting the hit region R1 compared to, for example, a case where the edges 11 and 21 are linear.

Further, since the curved portions 21a and 21b are arranged alternately from the base end side (the side of the intersection point P2) to the distal end side of the second slit 20, it is possible to more effectively suppress the edge 21 of the second slit 20 from rising from the hitting surface 106a when hitting the hit region R1. By suppressing the edge 21 from rising from the hitting surface 106a, peeling of the drum patch 1 from the hitting surface 106a can be suppressed.

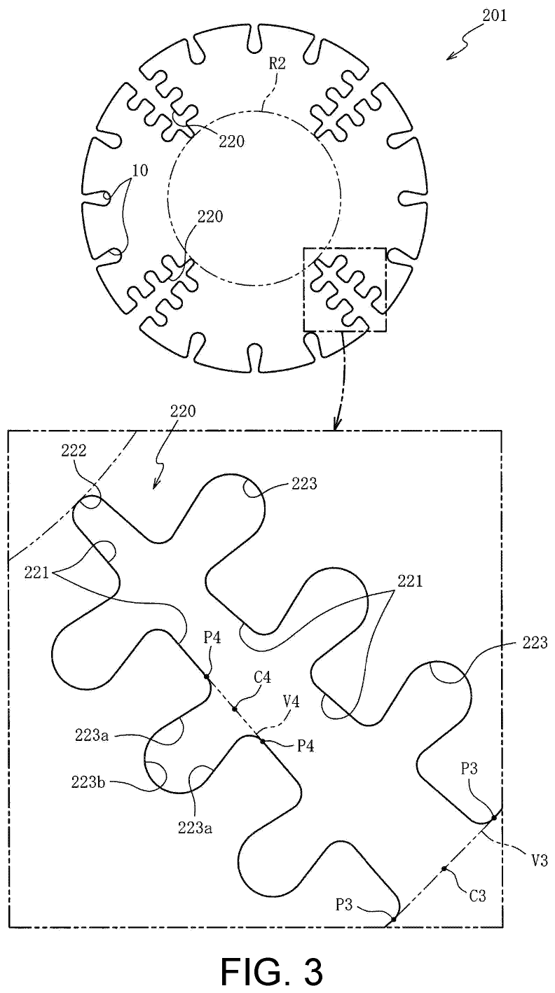

Next, a drum patch 201 of a second embodiment will be described with reference to FIG. 3. FIG. 3 is a front view of the drum patch 201 of the second embodiment. Furthermore, the same parts as in the drum patch 1 of the above-described first embodiment are indicated by the same reference numerals, and the description thereof will be omitted (the same applies to other embodiments described later).

As illustrated in FIG. 3, a plurality of (12 in this embodiment) first slits 10 and a second slit 220 having a deeper cutting depth than the first slits 10 are formed on the outer edge of the drum patch 201 of the second embodiment.

The plurality of second slits 220 are formed (at 4 positions in this embodiment) in the circumferential direction of the drum patch 201, and the intervals between the plurality of second slits 220 in the circumferential direction are constant. That is, the second slits 220 are formed at positions that equally divide the plurality of first slits 10 (four equal parts).

When the virtual circle contacting the edge of each second slit 220 is a hit region R2, also in this embodiment, the first slit 10 and the second slit 220 extending toward the hit region R2 are formed at the outer edge of the drum patch 201. Thus, the slits 10 and 220 can absorb deformation in which the outer edge portion of the drum patch 201 rises from the hitting surface 106a when hitting the hit region R2 (see FIG. 1).

Further, since the hit region R2 is surrounded by the plurality of radially extending first slits 10 and second slits 220, deformation in which the outer edge portion of the drum patch 201 rises from the hitting surface 106a can be effectively suppressed over the entire circumference of the drum patch 201.

As illustrated in the enlarged part of FIG. 3, when the line segment connecting the intersection points P3 between a pair of edges 221 extending in the longitudinal direction of the second slit 220 and the outer edge of the drum patch 201 is assumed as a virtual line V3, the length of the line segment connecting a tip of a tip edge 222 of the second slit 220 that connects the pair of edges 221 to the midpoint C3 of the virtual line V3 is the length of the second slit 220.

Also in this embodiment, since the length of the second slit 220 is greater than the first slit 10, the second slit 220 easily absorbs the undulating deformation of the drum patch 201 when hitting the hit region R2.

Further, since the number of second slits 220 (4) is smaller than the number of first slits 10 (12), it is possible to ensure a wide region outside the hit region R2 to receive the hitting from the beater 112 while suppressing the undulating deformation of the drum patch 201 by the second slit 220. Thus, the drum patch 201 can effectively protect the hitting surface 106a while suppressing the drum patch 201 from peeling off from the hitting surface 106a.

The pair of edges 221 of the second slit 220 is formed in a linear shape in which the distance between them gradually decreases as it goes toward the tip edge 222, and the pair of edges 221 is connected to each other by the arc tip edge 222. Accordingly, since it is possible to suppress the generation of cracks from the tip edge 222 of the second slit 220 due to the impact generated when hitting the hit region R2, the durability of the drum patch 201 can be improved.

Furthermore, a notch 223 extending outward in the width direction of the second slit 220 is formed in the edge 221 of the second slit 220. A plurality of the notches 223 are formed (at 3 positions in this embodiment) in the longitudinal direction of each edge 221 of the second slit 220.

When the line segment connecting the intersection points P4 between a pair of edges 223a extending in the longitudinal direction of the notch 223 (the radial direction of the drum patch 201) and the edge 221 of the second slit 220 is assumed as a virtual line V4, the length of the line segment connecting a tip of a tip edge 223b of the notch 223 that connects the pair of edges 223a to the midpoint C4 of the virtual line V4 is the length of the notch 223. The length of the notch 223 is formed into a slit shape shorter than the length of the second slit 220 (the length from the midpoint C3 to the tip edge 222).

By forming such a notch 223, the edge 221 of the second slit 220 is less likely to rise from the hitting surface 106a when hitting the hit region R2 compared to, for example, a case where the edge 221 of the second slit 220 is linear. Thus, peeling of the drum patch 201 from the hitting surface 106a can be suppressed.

Further, since the pair of edges 223a of the notch 223 is connected by the arc tip edge 223b, it is possible to suppress the generation of cracks from the tip edge 223b of the notch 223 due to the impact generated when hitting the hit region R2. Thus, the durability of the drum patch 201 can be improved.

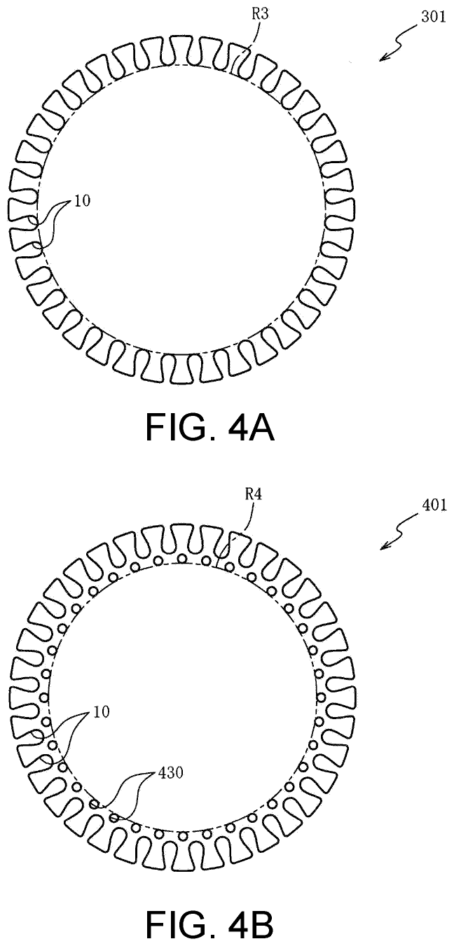

Next, drum patches 301 and 401 of third and fourth embodiments will be described with reference to FIG. 4A and FIG. 4B. FIG. 4A is a front view of the drum patch 301 of the third embodiment and FIG. 4B is a front view of the drum patch 401 of the fourth embodiment.

As illustrated in FIG. 4A, the drum patch 301 of the third embodiment is obtained by omitting the second slit 20 from the drum patch 1 (see FIG. 2) of the first embodiment and increasing the number of the first slits 10 to 36.

When the virtual circle contacting the edge of each first slit 10 is assumed as a hit region R3, also in this embodiment, the first slit 10 extending toward the hit region R3 is formed at the outer edge of the drum patch 301. Thus, each first slit 10 can absorb deformation in which the outer edge portion of the drum patch 301 rises from the hitting surface 106a (see FIG. 1) when hitting the hit region R3.

Furthermore, in this embodiment, only the first slit 10 is formed at the drum patch 301, but it is of course possible to omit the first slit 10 and form only the second slits 20 and 220 (see FIG. 2 and FIG. 3).

As illustrated in FIG. 4B, the drum patch 401 of the fourth embodiment is obtained by adding a circular through hole 430 to the drum patch 301 of the third embodiment. A plurality of the through holes 430 are arranged at equal intervals in the circumferential direction of the drum patch 401 and these through holes 430 are formed on the inner circumferential side of the first slit 10 (the radially inner side of the drum patch 401).

When the virtual circle contacting the edge of each through hole 430 is assumed as a hit region R4, the impact generated when hitting the hit region R4 is absorbed by each through hole 430 and hence such an impact can be suppressed from being transmitted to the outer circumferential side of each through hole 430.

The through hole 430 is formed at a position different from the first slit 10 in the circumferential direction of the hit region R4 (a position not overlapping the first slit 10 in the radial direction of the hit region R4). That is, since the first slits 10 and the through holes 430 are arranged alternately around the hit region R4, it is possible to suppress the impact generated when hitting the hit region R4 from being transmitted to a region between the first slits 10. Accordingly, it is possible to effectively suppress deformation in which the outer edge portion of the drum patch 401 rises from the hitting surface 106a.

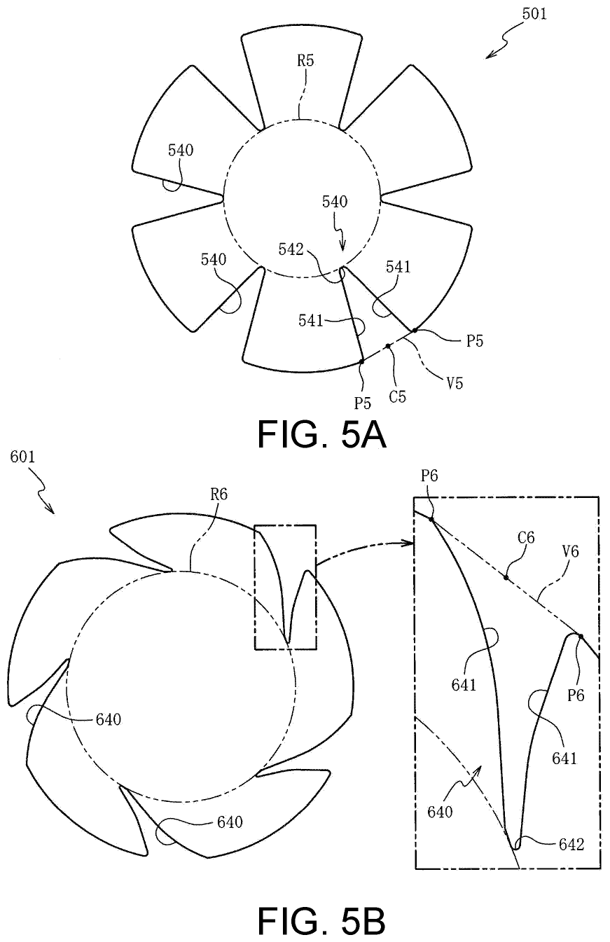

Next, drum patches 501 and 601 of fifth and sixth embodiments will be described with reference to FIG. 5A and FIG. 5B. FIG. 5A is a front view of the drum patch 501 of the fifth embodiment and FIG. 5B is a front view of the drum patch 601 of the sixth embodiment.

As illustrated in FIG. 5A, a plurality of (six in this embodiment) slits 540 are formed at the outer edge of the drum patch 501 of the fifth embodiment at equal intervals in the circumferential direction. A pair of edges 541 extending in the longitudinal direction of the slit 540 are formed in a linear shape such that the distance between them gradually decreases as it goes toward a tip edge 542 of the slit 540.

When the line segment connecting the intersection points P5 between the pair of edges 541 of the slit 540 and the outer edge of the drum patch 501 is assumed as a virtual line V5, the length of the line segment connecting the tip of the tip edge 542 of the slit 540 and the midpoint C5 of the virtual line V5 is the length of the slit 540. Since each of the plurality of slits 540 has the same length, the virtual circle contacting all slits 540 is a hit region R5.

Also in this embodiment, since the slit 540 extending toward the hit region R5 is formed at the outer edge of the drum patch 501, it is possible to suppress deformation in which the outer edge portion of the drum patch 501 rises from the hitting surface 106a (see FIG. 1) when hitting the hit region R5.

Further, since the pair of edges 541 of the slit 540 is connected by the arc tip edge 542, it is possible to suppress the generation of cracks from the tip edge 542 of the slit 540 due to the impact generated when hitting the hit region R5. Thus, the durability of the drum patch 501 can be improved.

As illustrated in FIG. 5B, a plurality of (in this embodiment, five) slits 640 are formed at the outer edge of the drum patch 601 of the sixth embodiment at equal intervals in the circumferential direction. The distance between the pair of edges 641 extending in the longitudinal direction of the slit 640 gradually decreases as it goes toward a tip edge 642.

When the line segment connecting the intersection points P6 between the pair of edges 641 of the slit 640 and the outer edge of the drum patch 601 is assumed as a virtual line V6, the length of the line segment connecting the tip of the tip edge 642 of the slit 640 and the midpoint C6 of the virtual line V6 is the length of the slit 640. Since each of the plurality of slits 640 has the same length, the virtual circle contacting all slits 640 is a hit region R6.

Also in this embodiment, since the slit 640 extending toward the hit region R6 is formed at the outer edge of the drum patch 601, it is possible to suppress deformation in which the outer edge portion of the drum patch 601 rises from the hitting surface 106a when hitting the hit region R6.

Further, in this embodiment, the slit 640 is inclined with respect to the radial direction of the drum patch 601 (the hit region R6). Accordingly, one slit 640 can effectively suppress the impact generated when hitting the hit region R6 from being transmitted to the outer edge side of the drum patch 601 (over a wide range in the circumferential direction).

Each of the pair of edges 641 of the slit 640 is curved inward in the width direction of the slit 640 (a curved portion is formed). Accordingly, it is possible to suppress the edge 641 of the slit 640 from rising from the hitting surface 106a when hitting the hit region R6 compared to a case in which the edge 641 of the slit 640 is linear.

Further, since the pair of edges 641 of the slit 640 is connected by the arc tip edge 642, it is possible to suppress the generation of cracks from the tip edge 642 of the slit 640 due to the impact generated when hitting the hit region R6. Thus, the durability of the drum patch 601 can be improved.

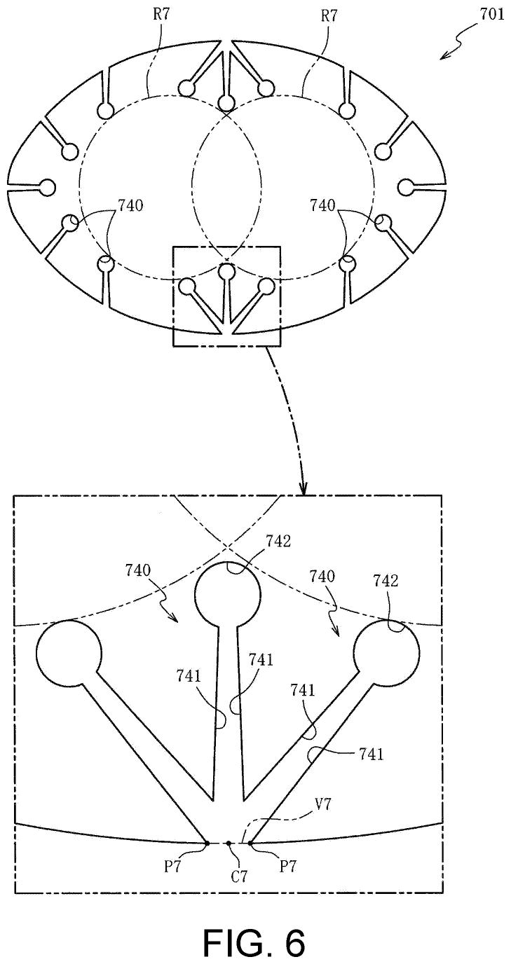

Next, a drum patch 701 of a seventh embodiment will be described with reference to FIG. 6. FIG. 6 is a front view of the drum patch 701 of the seventh embodiment.

As illustrated in FIG. 6, the outer shape of the drum patch 701 of the seventh embodiment is formed into an elliptical shape extending from left to right. A plurality of (in this embodiment, 16) slits 740 are formed on the outer edge of the drum patch 701 to be arranged in the circumferential direction. The distance between the pair of edges 741 extending in the longitudinal direction of the slit 740 gradually decreases as it goes toward a tip edge 742.

When the line segment connecting the intersection points P7 between the pair of edges 741 of the slit 740 and the outer edge of the drum patch 701 is assumed as a virtual line V7, the length of the line segment connecting the tip of the tip edge 742 of the slit 740 and the midpoint C7 of the virtual line V7 is the length of the slit 740.

Although a part of the slits 740 are set to different lengths from the other slits 740 in the plurality of slits 740, the virtual circle with the largest diameter is a hit region R7 among the virtual circles that contact the tip edges 742 of three or more slits 740 and do not intersect the other slits 740. The hit regions R7 are formed in a pair on the left and right with the center of the drum patch 701 interposed therebetween so that the hit regions R7 partially overlap each other. That is, in this embodiment, it is assumed that the hitting surface 106a is protected from hitting by the twin-pedal type foot pedal 110 having two beaters 112 (see FIG. 1) and the hit region R7 is disposed at the position hit by the two beaters 112.

Since the plurality of slits 740 extending toward each of the pair of hit regions R7 is formed at the outer edge of the drum patch 701, it is possible to suppress deformation in which the outer edge portion of the drum patch 701 rises from the hitting surface 106a when hitting the hit region R7. Further, since the slits 740 are arranged along each of the pair of assumed hit regions R7, a wide hit region R7 can be ensured.

Further, since the pair of edges 741 of the slit 740 is connected by the arc tip edge 742, it is possible to suppress the generation of cracks from the tip edge 742 of the slit 740 due to the impact generated when hitting the hit region R7. Thus, the durability of the drum patch 701 can be improved.

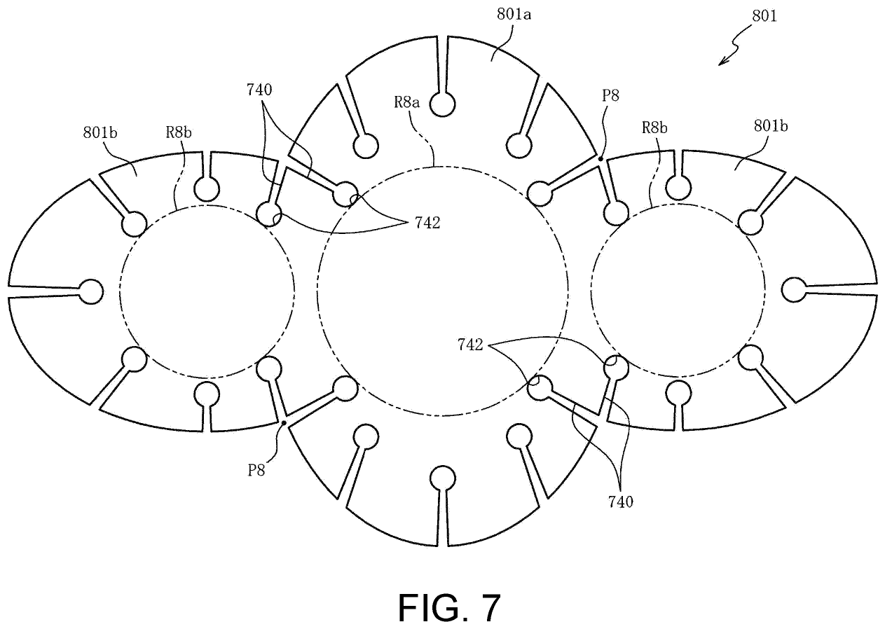

Next, a drum patch 801 of an eighth embodiment will be described with reference to FIG. 7. FIG. 7 is a front view of the drum patch 801 of the eighth embodiment.

As illustrated in FIG. 7, the drum patch 801 of the eighth embodiment includes a main body portion 801a which forms a center portion thereof and an overhang portion 801b which protrudes from the main body portion 801a to the left and right and these portions 801a and 801b are integrally formed.

The main body portion 801a is formed in an elliptical shape extending vertically, and the left and right overhang portions 801b are formed in a semi-elliptic shape extending left and right from the main body portion 801a. That is, the outer shape of the drum patch 801 is a shape of a plurality of overlapping ellipses.

The plurality of slits 740 are formed at the outer edges of the main body portion 801a and the overhang portion 801b in the circumferential direction (in this embodiment, 10 slits are provided in the main body portion 801a and 7 slits are provided in each overhang portion 801b, for a total of 24 slits). The slit 740 has the same shape as the slit 740 of the above-described seventh embodiment (sec FIG. 6).

Although a part of the slits 740 are set to different lengths from the other slits 740 in the plurality of slits 740, the virtual circle with the largest diameter is a first hit region R8a among the virtual circles that contact the tip edges 742 of three or more slits 740 and do not intersect the other slits 740. The first hit region R8a is formed in the main body portion 801a. Further, when a virtual circle is drawn that contacts the tip edges 742 of three or more of slits 740 that are not in contact with the first hit region R8a and does not intersect with the other slits 740, the virtual circle with the largest diameter is a second hit region R8b. The second hit region R8b is formed at one position of each of the pair of overhang portions 801b.

That is, in this embodiment, it is assumed that hitting is received by the first hit region R8a of the main body portion 801a when the single-pedal type foot pedal 110 having one beater 112 (see FIG. 1) is used and hitting is received by the second hit regions R8b of the pair of overhang portions 801b when the twin-pedal type foot pedal 110 having two beaters 112 is used.

Since the plurality of slits 740 extending toward each of three hit regions R8a and R8b are formed at the outer edge of the drum patch 801 (the main body portion 801a and the overhang portion 801b), it is possible to suppress deformation in which the outer edge portion of the drum patch 801 rises from the hitting surface 106a when hitting the hit regions R8a and R8b. Furthermore, since the slits 740 are arranged along each of the three assumed hit regions R8a and R8b, wide hit regions R8a and R8b can be ensured.

Further, since the slit 740 is formed at the intersection point P8 between the outer edge of the main body portion 801a and the outer edge of the overhang portion 801b, it is possible to suppress the generation of cracks from the intersection point P8 due to the impact generated when hitting the hit regions R8a and R8b. Thus, the durability of the drum patch 801 can be improved.

Although the above has been described based on the above-described embodiments, the disclosure is not limited to the above-described embodiments. Then, it can be easily inferred that various improvements and modifications can be made without departing from the spirit of the disclosure.

A part or all of the drum patches 1, 201, 301, 401, 501, 601, 701, and 801 (hereinafter, collectively referred to as “drum patches 1 to 801”) of the above-described embodiments may be combined with a part or all of the other embodiments to configure a drum patch. That is, for example, a part or all of the first slit 10, the second slits 20 and 220, the through hole 430, or the slits 540, 640, and 740 may be formed in one drum patch.

In the above-described embodiments, a case has been described in which the drum patches 1 to 801 are adhered to the hitting surface 106a of the attachment 106 attached to the drum 100 (bass drum), but the disclosure is not necessarily limited thereto. For example, the drum patches 1 to 801 may be directly attached to the head 102 (hitting surface) of the drum 100 without the attachment 106 and the drum patches 1 to 801 may be attached to the hitting surface of the snare or tom. That is, the drum patches 1 to 801 may be attached to the hitting surface of the electronic percussion instrument imitating the drum, or the drum patches 1 to 801 may be attached to the hitting surface of the acoustic drum.

In the above-described embodiments, a case has been described in which the entire hitting surface 106a hit by the player is covered with the drum patches 1 to 801, but a configuration may also be adopted in which a partial area of the hitting surface 106a is covered with the drum patches 1 to 801.

In the above-described embodiments, a case where the outer shapes of the drum patches 1 to 801 are circular (elliptical) or a combination of elliptical shapes has been described, but the disclosure is not necessarily limited thereto. For example, the outer shapes of the drum patches 1 to 801 may be polygonal (for example, a diamond or a rectangle), or may be a combination of circles and polygons. That is, the outer shapes of the drum patches 1 to 801 can be appropriately set if the hitting surface 106a can be protected.

Although the description was omitted in the above-described embodiments, the drum patches 1 to 801 include a first adhesive layer which is adhered to the hitting surface 106a, a resin film which is superimposed on the first adhesive layer, a second adhesive layer which is superimposed on the resin film, and a cloth which is superimposed on the second adhesive layer. The first adhesive layer is a double-sided tape in which an adhesive is held on a base material (film or cloth), and the second adhesive layer is a double-sided tape without such a base material.

However, the drum patches 1 to 801 are not limited to laminated materials such as those described above. For example, the first adhesive layer may be formed using a double-sided tape not having a base material or the second adhesive layer may be formed using a double-sided tape having the same material as the first adhesive layer. Further, the drum patches 1 to 801 made of one layer of woven fabric, non-woven fabric, or resin film may be adhered to the hitting surface 106a with a double-sided tape. That is, the materials of the drum patches 1 to 801 can be appropriately set if the hitting surface 106a can be protected.

In the above-described embodiments, a case has been described in which the longitudinal direction of the first slit 10, the second slits 20 and 220, and the slit 540 is along the radial direction of the drum patch, but the disclosure is not necessarily limited thereto. For example, these slits 10, 20, 220, and 540 may be inclined with respect to the radial direction of the drum patch (hit region) as in the slit 640 of the sixth embodiment.

In the above-described embodiments, a case has been described in which the first slit 10, the second slits 20 and 220, the through hole 430, and the slits 540, 640, and 740 are formed at a plurality of positions of the drum patches 1 to 801, but the number of the slits or through holes may be one.

In the above-described embodiments, for example, a case has been described in which the lengths and intervals between the first slits 10 are constant, but the lengths and intervals between the first slits 10 may be different. The same applies to the second slits 20 and 220 or the slits 540 and 640.

Although a case has been described in which the curved portions 21a and 21b are formed at the edge 21 of the second slit 20 in the above-described first embodiment and the notch 223 is formed in the second slit 220 in the above-described second embodiment, the curved portion or notch may be formed in the first slit 10 or the slits 540, 640, and 740 or the curved portions 21a and 21b or the notch 223 may be omitted (for example, the edges 11 and 21 of the slits 10 and 20 are formed in a linear shape).

In the above-described embodiments, a case has been described in which the tip edges 12, 22, 223b, 542, 642, and 742 of the first slit 10, the second slits 20 and 220, the notch 223, and the slits 540, 640, and 740 have an arc shape, but such tip edges 12, 22, 223b, 542, 642, and 742 may have an acute angle.

In the above-described first and second embodiments, a case has been described in which the number of the second slits 20 and 220 is smaller than the number of the first slits 10, but the number of the first slits 10 may be the same as the number of the second slits 20 and 220 or the number of the second slits 20 and 220 may be larger than the number of the first slits 10.

In the above-described fourth embodiment, a case has been described in which the through hole 430 is circular, but the disclosure is not necessarily limited thereto. For example, the through hole 430 may have a polygonal shape or a long hole shape. That is, the shape of the 10 through hole 430 can be appropriately set if the hole penetrates the drum patch.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A drum patch that is formed into a sheet shape and is able to be adhered to a hitting surface of a drum,
wherein a slit extending toward a hit region receiving hitting is formed at an outer edge.

2. The drum patch according to claim 1,
wherein the hit region is surrounded by a plurality of the slits.

3. The drum patch according to claim 2,
wherein the slit comprises at least a first slit and a second slit having a greater length than the first slit.

4. The drum patch according to claim 3,
wherein the number of the second slits is smaller than the number of the first slits.

5. The drum patch according to claim 1,
wherein an edge extending in a longitudinal direction of the slit is provided with a curved portion having a curved shape protruding inward or outward in a width direction of the slit.

6. The drum patch according to claim 5,
wherein the curved portions having a curved shape protruding inward in the width direction of the slit and the curved portions having a curved shape protruding outward in the width direction of the slit are arranged alternately in the longitudinal direction of the slit.

7. The drum patch according to claim 2,
wherein the slits radially surround the hit region.

8. The drum patch according to claim 2, further comprising:
a plurality of through holes which surround the hit region,
wherein the slit and the through hole are formed at different positions in a direction around an outer circumference of the hit region.

9. The drum patch according to claim 2,
wherein each of a plurality of the hit regions is surrounded by a plurality of the slits.

10. The drum patch according to claim 1,
wherein a tip edge of the slit connecting edges extending in a longitudinal direction of the slit has an arc shape.

11. The drum patch according to claim 1,
wherein a slit-shaped notch extending outward in a width direction of the slit is formed at an edge extending in a longitudinal direction of the slit.

12. The drum patch according to claim 11,
wherein a tip edge of the notch connecting edges extending in a longitudinal direction of the notch has an arc shape.

13. A hitting surface protection method for protecting a hitting surface of a drum using a drum patch formed in a sheet shape, comprising: configuring the drum patch in which a slit extending toward a hit region receiving hitting to be formed at an outer edge of the drum patch; and
adhering the drum patch to the hitting surface.

14. The method according to claim 13, wherein the slit comprises a plurality of slits and the plurality of slits surround the hit region.

15. The method according to claim 14, wherein the slit comprises at least a first slit and a second slit having a greater length than the first slit.

16. The method according to claim 15, wherein the number of the second slits is smaller than the number of the first slits.

17. The method according to claim 13, wherein the drum patch is configured such that an edge extending in a longitudinal direction of the slit is provided with a curved portion having a curved shape protruding inward or outward in a width direction of the slit.

18. The method according to claim 17, wherein the curved portions having a curved shape protruding inward in the width direction of the slit and the curved portions having a curved shape protruding outward in the width direction of the slit are arranged alternately in the longitudinal direction of the slit.

19. The method according to claim 14, wherein the drum patch is configured such that the slits radially surround the hit region.

20. The method according to claim 14, wherein the drum patch is configured to have a plurality of through holes surrounding the hit region.
